(19) United States
(12) Patent Application Publication
(10) Pub. No.: US 2013/0082151 A1
(43) Pub. Date: Apr. 4, 2013

(54) MOUNTING DEVICE FOR LIGHT PIPE

(71) Applicant: LEI LIU, Shenzhen City (CN)

(72) Inventor: LEI LIU, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/271,255

(22) Filed: Oct. 12, 2011

(30) Foreign Application Priority Data
Sep. 30, 2011 (CN) 201110294012.6

(51) Int. Cl. F16L 3/22

(52) U.S. Cl. 248/68.1

(57) ABSTRACT

A mounting device for mounting a number of light pipes includes a connector and a frame attached to the connector. A number of clamping portions are formed on the outer surface of the frame to fix the light pipes.

### BACKGROUND

1. Technical Field

The present disclosure relates to a device for mounting a plurality of light pipes.

2. Description of Related Art

Many Small Form-factor Plug gables (SFPs) mounted on circuit boards need to show their working state with light-emitting diodes (LEDs). However many light pipes transmitting light for the LEDs are mounted on the tops of connectors of the SFPs. As a result, when an adapter card needs to be mounted above an SFP of a circuit board, a space between the adapter and the circuit board may not be enough for mounting light pipes to the top of the connector of the SFP, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a mounting device with a number of light pipes.

FIG. 2 is an assembled, isometric view of the fixing device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

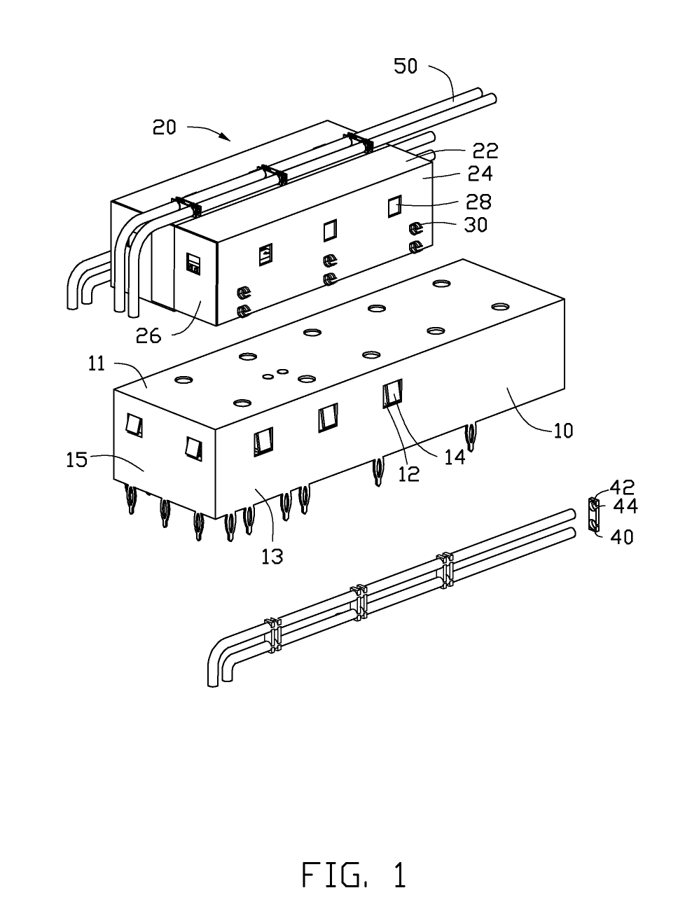

Referring to FIG. 1, an exemplary embodiment of a mounting device for mounting a plurality of light pipes 50 includes a connector 10, a frame 20 and a plurality of blocking portions 40.

The connector 10 is substantially rectangular, and includes a top wall 11, two sidewalls 13 perpendicularly extending down from opposite sides of the top wall 11, and an end wall 15 perpendicularly extending down from an end of the top wall 11. Each of the sidewalls 13 and end wall 15 defines a plurality of openings 12. An elastic engaging piece 14 slantingly extends down and out from a top side bounding each opening 12.

The frame 20 is substantially rectangular, and includes a top plate 22, two side plates 24 perpendicularly extending down from opposite sides of the top plate 22, and an end plate 26 perpendicularly extending down from an end of the top plate 22. Each of the side plates 24 and end plate 26 defines a plurality of engaging holes 28 corresponding to the engaging pieces 14. The side plates 24 and the top plate 22 each longitudinally form two rows of C-shaped clamping portions 30 which are elastic.

Each blocking portion 40 is a flat plate which is made of elastic material. Each blocking portion 40 defines two through holes 40 in the centre, and two openings 44 communicating with the corresponding through holes 40 on a side.

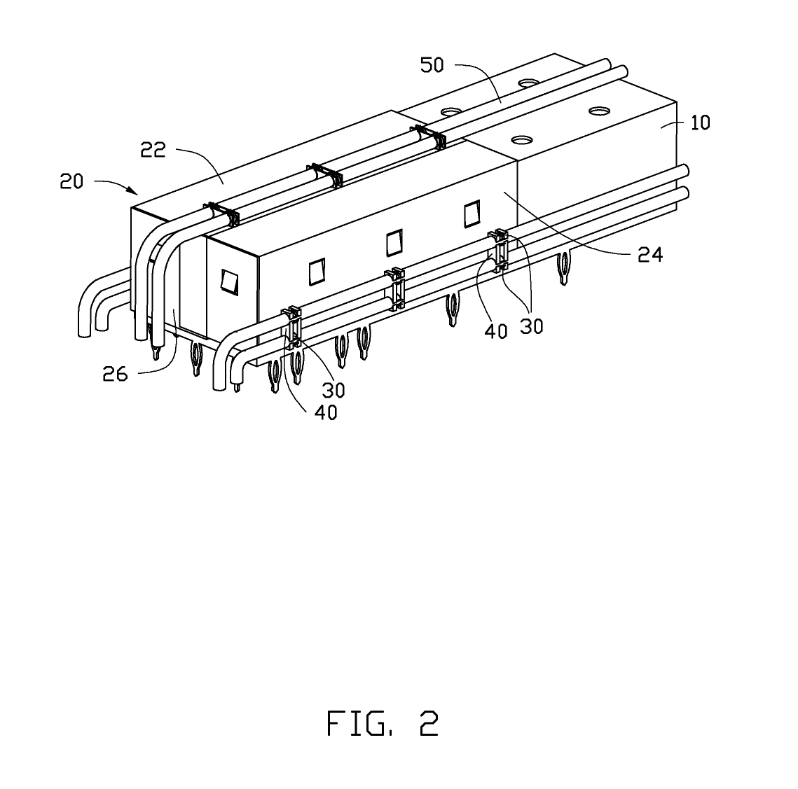

Referring to FIG. 2, in assembly, the frame 20 encloses the connector 10. The top plate 22 is supported on the top wall 11, the side plates 24 are attached to the outer surfaces of the corresponding sidewalls 13, and the end plate 26 is attached to the outer surface of the end wall 15. The side plates 24 and the end plate 26 deform the engaging pieces 14 when moving down, until the engaging pieces 14 are aligned with the corresponding engaging holes 28. The engaging pieces 14 are then restored to engage in the corresponding engaging holes 28.

In use, two light pipes 50 are extended through the openings 44 to be engaged in the through holes 42 of two blocking portions 40 arranged side by side. The light pipes 50 are then engaged in the two rows of clamping portions 30 of a corresponding one of the top plate 22 and the side plates 24. The blocking portions 40 abut against opposite sides of a corresponding one of each row of clamping portions 30.

In another embodiment, one of the side plates 24 may be omitted.

In another embodiment, the light pipes 50 may be mounted to the frame 20 by other means, such as by glue.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for mounting a plurality of light pipes, the mounting device comprising:
a connector; and
a frame attached to the connector, and comprising a plurality of clamping portions to fix the light pipes.

2. The mounting device of claim 1, wherein the frame is substantially rectangular, and comprises a top plate, some of the clamping portions are longitudinally formed on the top plate.

3. The mounting device of claim 2, wherein the frame further comprises a side plate extending down from a side of the top plate, other clamping portions are longitudinally formed on the side plate.

4. The mounting device of claim 3, wherein the frame further comprises an end plate extending down from an end of the top plate, the side plate and the end plate of the frame each define a plurality of engaging holes, the connector is substantially rectangular, a plurality of engaging pieces slantingly extend down and out from a side and an end of the connector to engage in the engaging holes.

5. The mounting device of claim 4, wherein the side and end of the connector each define a plurality of openings, each engaging piece slantingly extends down and out from a top side bounding a corresponding one of the openings.

6. The mounting device of claim 1, further comprising a plurality of blocking portions to clamp the light pipes, wherein two adjacent ones of the blocking portions sandwich a corresponding one of the clamping portions.

7. The mounting device of claim 6, wherein the blocking portions are made of elastic material.

8. The mounting device of claim 7, wherein each blocking portion defines a through hole to accommodate a corresponding light pipe, and an opening extending through a side of the blocking portion and communicating with the through hole.

9. The mounting device of claim 1, wherein each clamping portion is substantially C-shaped.
